(19) United States
(12) Patent Application Publication
(10) Pub. No.: US 2007/0160365 A1
(43) Pub. Date: Jul. 12, 2007

(54) Image capture system, handheld terminal device, and image server

(75) Inventor: Yoshiro Aoyagi, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/542,112

(22) Filed: Oct. 4, 2006

(30) Foreign Application Priority Data
Oct. 5, 2005 (JP) 2005-292809

(51) Int. Cl. G03B 19/00

(52) U.S. Cl. 396/429

(57) ABSTRACT

An image capture system includes a mobile camera phone and an image server connected to this mobile phone through a communication network. The mobile phone transmits subject type information of a next image capture session to the image server. The image server searches an image database for the images classified into the same subject type as received, and sends photographing position information of the retrieved images to the mobile phone. The mobile phone subsequently compares this photographing position information with a current position determined based on GPS signals, and displays a presence possibility of the desired subject within the area on a display panel. After the image capture, the mobile phone sends the captured image to the image server. The image server classifies and records the captured image into the image database according to the subject type information.

### FIELD OF THE INVENTION

The present invention relates to an image capture system comprising handheld terminal devices with an image capture function and a communication function, and an image server for managing captured images sent from the handheld terminal devices.

### BACKGROUND OF THE INVENTION

Mobile phones with an Internet access function and an image capture function are widely used. Such mobile phones enable the users to make an easy image capture and immediate transport of the captured images to other mobile phones and personal computers that are coupled to the Internet. Recently, some mobile phones are equipped with a GPS (Global Positioning System) capability to determine a current position of the mobile phone itself.

Since the mobile phones are mainly used outdoors, the users hardly have detailed information (such as, name, kind, and feature) of a subject (i.e., animal or plant) at the time of image capture. In view of this, there are proposed several image capture systems in which a user sends the image captured on a handheld terminal device such as a mobile phone via Internet to a server, which identifies a subject of the image and sends back the information about the subject to the handheld terminal device (see, for example, Japanese patent laid-open publications No. 2003-132062, No. 2003-323620, and No. 2004-145416).

However, these image capture systems are only to identify the subject of the captured image that is sent from the handheld terminal device.

### SUMMARY OF THE INVENTION

In view of the foregoing, a primary object of the present invention is to provide an image capture system which enables a user to know a possibility to capture images of a desired subject at a current position by using a position determining function of a handheld terminal device.

Another object of the present invention is to provide the handled terminal device used in the above image capture system.

Still another embodiment of the present invention is to provide an image server which makes data communication with the handheld terminal device of the above image capture system.

In order to achieve the above and other objects, an image capture system according to the present invention includes a handheld terminal device with an image capture and communication functions and an image server that establishes data communication with the handheld terminal device through a communication interface. The handheld terminal device is equipped with a position determiner, a setup device, a communication controller, and an indicator. The position determiner determines a current position of the handheld terminal device. The setup device is used to specify a type of a subject, or a subject type which the user is going to capture. At standby time to image capture, the communication controller transmits the subject type to the image server while it transmits a captured image together with photographing position information to the image server after the image capture. Based on the photographing position information provided by the image server, the indicator estimates and indicates a presence possibility of the subject within a certain radius from the current position. The image server is equipped with a sorter, a database, and a search device. The sorter classifies the captured image sent from the handheld terminal device, according to the subject type. The database stores the captured image sorted by the sorter. The search device searches the database for the images under the same subject type as sent from the handheld terminal device, and transmits the photographing position information derived from the retrieved images to the handheld terminal device.

Preferably, the handheld terminal device is a mobile camera phone. It is also preferable that the position determiner determines the current position by receiving GPS signals from a GPS satellite. In addition, it is preferable that the indicator shows the presence possibility of the subject on a display panel provided in the handheld terminal device.

In another embodiment of the present invention, a terminal device is connected to the communication network. This terminal device is configured to display the captured image and to accept an input of a reply about the subject type. When the captured image is sent from the handheld terminal device with no subject type specified, the sorter transmits this captured image along with an unclassifiable notice to the terminal device. The sorter then classifies this captured image according to the reply from the terminal device.

In still another embodiment of the present invention, a plurality of terminal devices are connected to the communication network. When the captured image is sent from the handheld terminal device with no subject type specified, the sorter sends this captured image along with the unclassifiable notice to all the terminal devices. The sorter then classifies this captured image according to the subject type most frequently inputted to the terminal devices.

According to the image capture system of the present invention, the handheld terminal device receives the photographing position information (photographing positions in the past) of a desired subject from the image server, and indicates the presence possibility of the subject within a certain area from the current position. Thereby, the user is able to know the possibility to capture the image of the desired subject, and to avoid missing a chance for image capture.

### BRIEF DESCRIPTION OF THE DRAWINGS

The above objects and advantages of the present invention will become more apparent from the following detailed description when read in connection with the accompanying drawings, in which:

FIG. 1 is a block diagram of an image capture system according to the present invention;

FIG. 2 is a block diagram of a mobile phone;

FIG. 3 is an explanatory view showing exemplary relation between a current position of the mobile phone and photographing positions of a subject in the past;

FIG. 4 is an explanatory view showing typical messages on a display panel;

FIG. 5 is a flow chart of operations in the image capture system;

FIG. 6 is a block diagram of an image capture system according to a second embodiment of the present invention; and

FIG. 7 is a block diagram of an image capture system according to a third embodiment of the present invention.

### DETAILED DESCRIPTION OF THE PREFERRED EMBODIMENTS

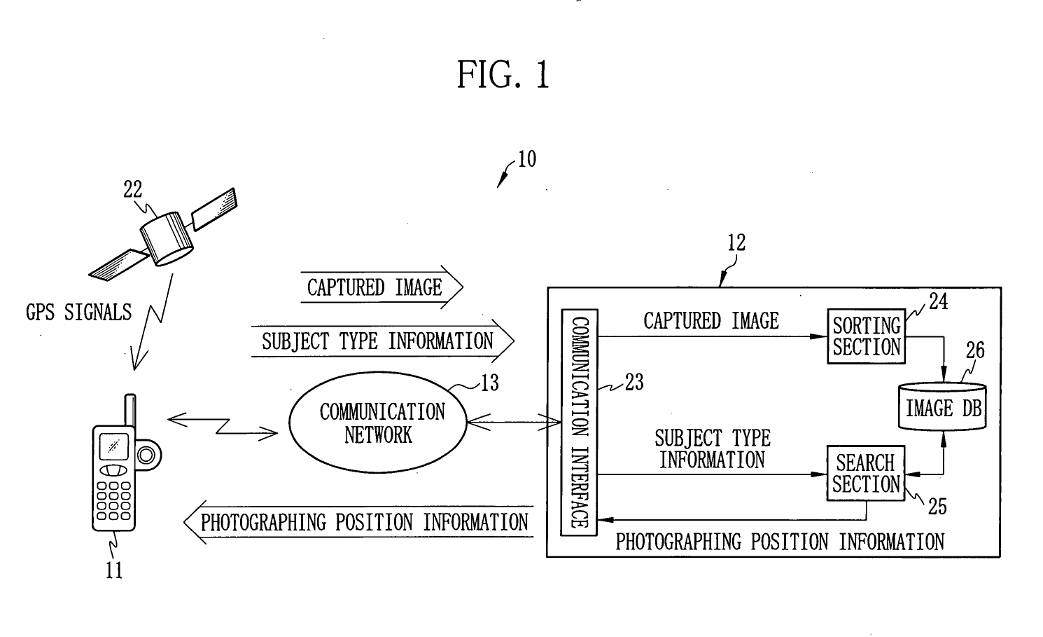

Referring to FIG. 1, an image capture system 10 is composed of a mobile camera phone (hereinafter, a mobile phone) 11 and an image server 12 that manages the captured images sent from the mobile phone 11. The mobile phone 11 is able to establish a data communication with the image server 12 over a communication network 13 such as a mobile communication network or Internet.

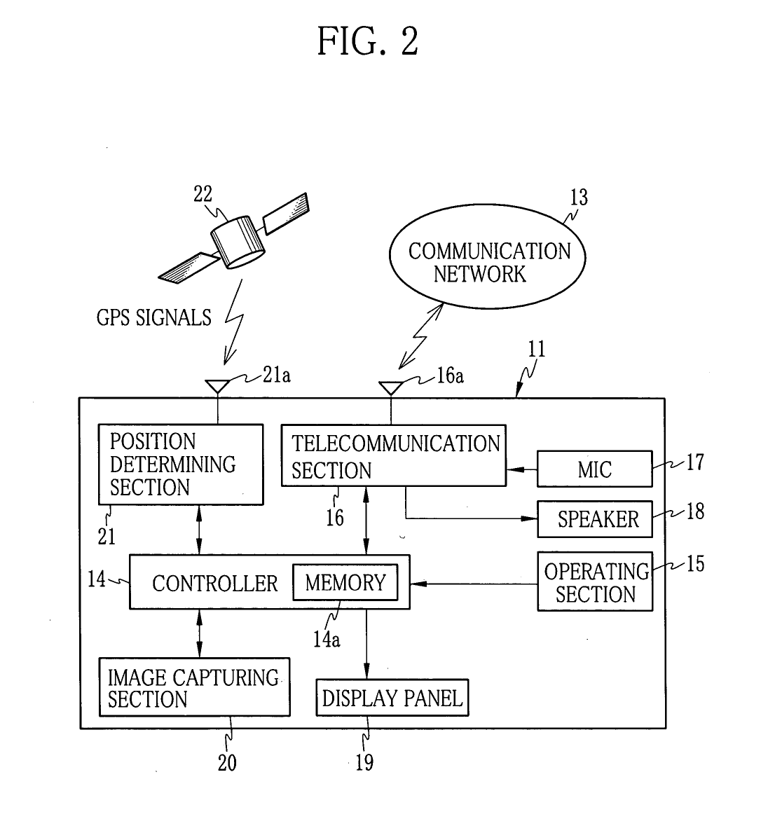

As shown in FIG. 2, the mobile phone 11 has a controller 14, an operating section 15, a telecommunication section 16, a microphone 17, a speaker 18, a display panel 19, an image capturing section 20, and a position determining section 21. The controller 14 controls each components of the mobile phone 11 according to operation commands that the user inputs through the operating section 15. The telecommunication section 16 transmits sounds (or voices) on the microphone 17 from an antenna 16a through radio waves while it receives the radio waves by the antenna 16a and outputs them as sounds from the speaker 18. Additionally, in an image capture mode, the telecommunication section 16 transmits various data such as the captured images from the antenna 16a, and inputs the data received by the antenna 16a into the controller 14.

The image capturing section 20 captures an subject image when an image capture command is entered on the operating section 15. The subject image is photoelectrically converted by a solid state imaging device of the image capturing section 20 and digitized to become a captured image, which is sent to the controller 14.

The position determining section 21 has a built-in GPS antenna 21a and receives GPS signals from GPS satellites 22 when determining a current position (i.e., latitude and longitude) of the mobile phone 11. The information of the current position is sent to the controller 14.

The controller 14 has a memory 14a. The memory 14a stores the captured images from the image capture section 20 and the current position information from the position determining section 21, as well as various setup information. By manipulating the operating section 15, the user specifies a type of a subject for a next image capture session, which is then stored in the memory 14a.

Under the control of the controller 14, the mobile phone 11 sends the type of subject (subject type information), stored in the memory 14a, to the image server 12 through the communication network 13 during the standby time to image capture. Additionally, the mobile phone 11 sends the current position information (i.e., photographing position information) determined by the position determining section 21 together with the captured image to the image server 12 after the image capture. Incidentally, this communication is controlled by the controller 14.

As shown in FIG. 1, the image server 12 has a communication interface 23, a sorting section 24, a search section 25, and an image database (DB) 26. The communication interface 23 communicates with the mobile phone 11 through the communication network 13 to send and receive various data. The sorting section 24 classifies the captured image, received by the communication interface 23, according to the type of subject and then records the image into the image DB 26. The image DB 26 stores a plurality of the captured images taken by other mobile phones 11 at various positions (or locations). The image DB 26 is updated every time the image server 12 receives a newly captured image.

The search section 25 searches the image DB 26 for the images classified into the same subject type as received by the communication interface 23. Then, the search section 25 derives the photographing position information (photographing positions in the past) from the retrieved images. This photographing position information is sent from the communication interface 23 to the mobile phone 11.

The mobile phone 11 receives the photographing position information through the telecommunication section 16 and stores it into the memory 14a. The controller 14 compares the current position, determined by the position determining section 21, with the photographing position information recently stored in the memory 14a and then shows, on the display panel 19, a presence possibility (message) of the subject within a certain area from the current position.

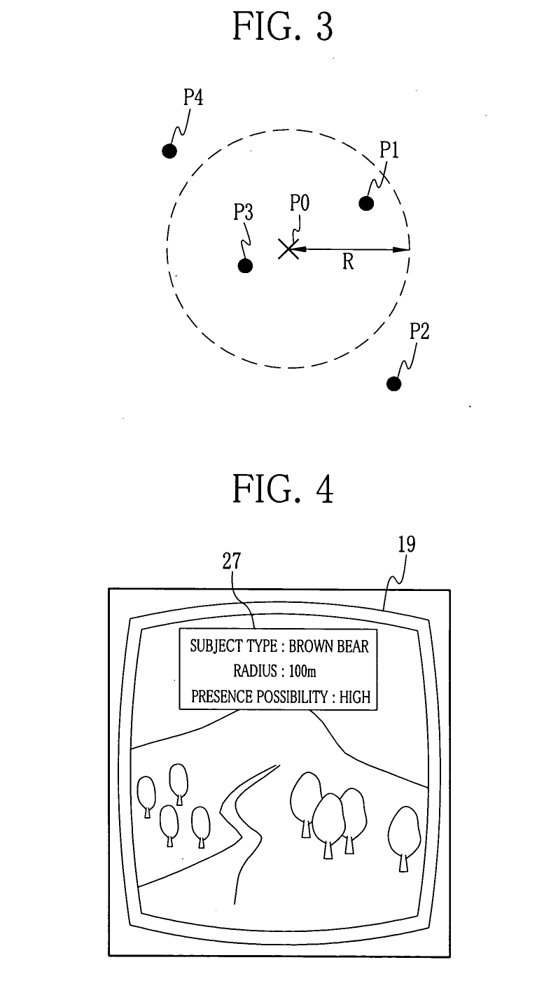

One example is shown in FIG. 3, where the area is defined within a radius R from a current position (P0) of the mobile phone 11, and the image server 12 derives the past photographing positions (P1 to P4) for the specified subject as the photographing position information. In this case, the display panel 19 shows a message 27 such as shown in FIG. 4. Reading this message, the user of the mobile phone 11 recognizes that the current position P0 is a customary territory of the subject and probably provides a chance for capturing the image of the subject.

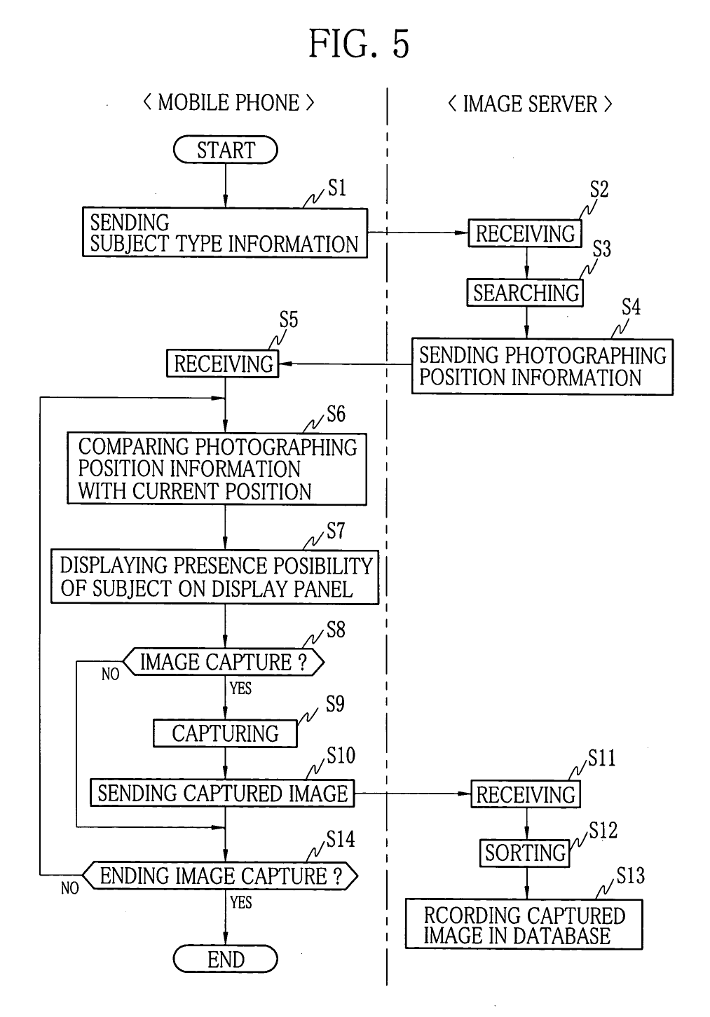

Next, the operation of the image capture system is explained with reference to a flowchart of FIG. 5. When the mobile phone 11 goes into a standby state in the image capture mode, the type of subject specified through the operating section 15 is sent as the subject type information from the telecommunication section 16 to the image server 12 (S1). The communication interface 23 of the image server 12 receives the subject type information (S2), and the search section 25 searches the image DB 26 for the images classified into the same subject type as received (S3). The search section 25 derives the photographing position information from the retrieved images, and sends this information to the mobile phone 11 through the communication interface 23 (S4).

The mobile phone 11 receives the photographing position information from the image server 12 through the telecommunication section 16 and stores it into the memory 14a (S5). The controller 14 obtains and stores the information of the current position from the position determining section 21 into the memory 14a, and compares the recently received photographing position information with the current position (S6). The controller 14 subsequently drives the display panel 19 to show the presence possibility of the subject within the area (S7).

When an image capture command is provided on the operating section 15 (YES in S8), the image capturing section 20 executes the image capture operation, and the captured image is stored in the memory 14a (S9). This captured image is sent from the telecommunication section 16 to the image server 12 (S10), and received by the communication interface 23 of the image server 12 (S1). The sorting section 24 classifies the captured image according to the subject type information (S12), and records the image into the image DB 26 (S13). In a similar manner, the captured images of other mobile phones 11 are also recorded into the image DB 26 on occasion.

Until a termination command is provided (NO in S14) through the operating section 15 (by switching to a different mode, for example), the mobile phone 11 performs the steps S6 to S13 repeatedly. When the termination command is provided (YES in S14), the image capture mode is ended. With the operation of the image capture system 10 as described above, the user of the mobile phone 11 easily knows the possibility to capture the image of the desired subject and, therefore, avoids missing a chance for image capture.

In the above embodiment, the presence possibility of the subject is indicated in the form of a message on the display panel 19. Instead of this, an LED on the mobile phone 11 or sound may be used for indication.

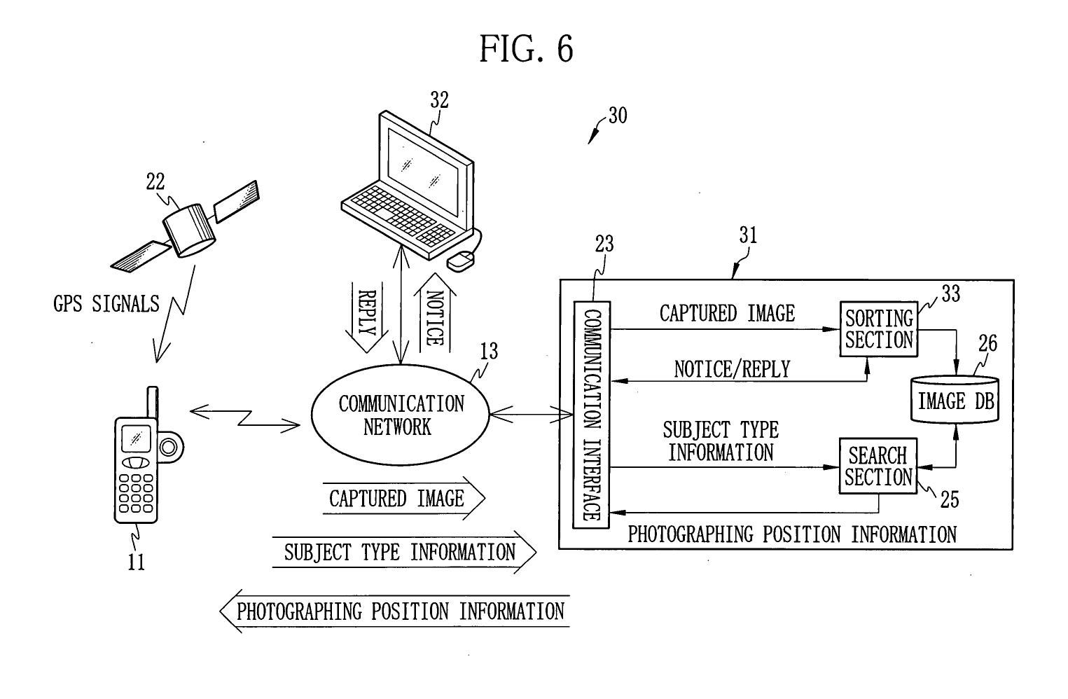

Next, a second embodiment of the present invention is explained. As shown in FIG. 6, an image capture system 30 is composed of the mobile phone 11, an image server 31, and a personal computer (PC) 32, all of which are connected to the communication network 13. In the drawing, the same components as those in the first embodiment are referred to by the same reference numerals, and the detailed explanations thereof are omitted.

The image server 31 is different from the image server 12 in a sorting section 33. In addition to classify and record the captured images into the image DB 26, the sorting section 33 sends a newly captured image to the PC 32, when the type of the subject for this image is not specified by the user (because the subject is an unfamiliar animal or plant, for example), along with a notice that the captured image is not classifiable. Afterward, the sorting section 33 receives a reply (about the type of subject) from the PC 32, and classifies and records the captured image into the image DB 26 according to the reply.

The PC 32 is configured to display the captured image and the notice, and to accept an input of a reply about the type of the subject. The PC 32 is operated by experts in various fields, who will input an appropriate reply to the PC 32.

As described above, the image capture system 30 asks the experts in various fields for the type of the subject by way of the PC 32 when the subject of the image captured on the mobile phone 11 is unspecifiable to the user. Thereby, the captured images are always classified appropriately.

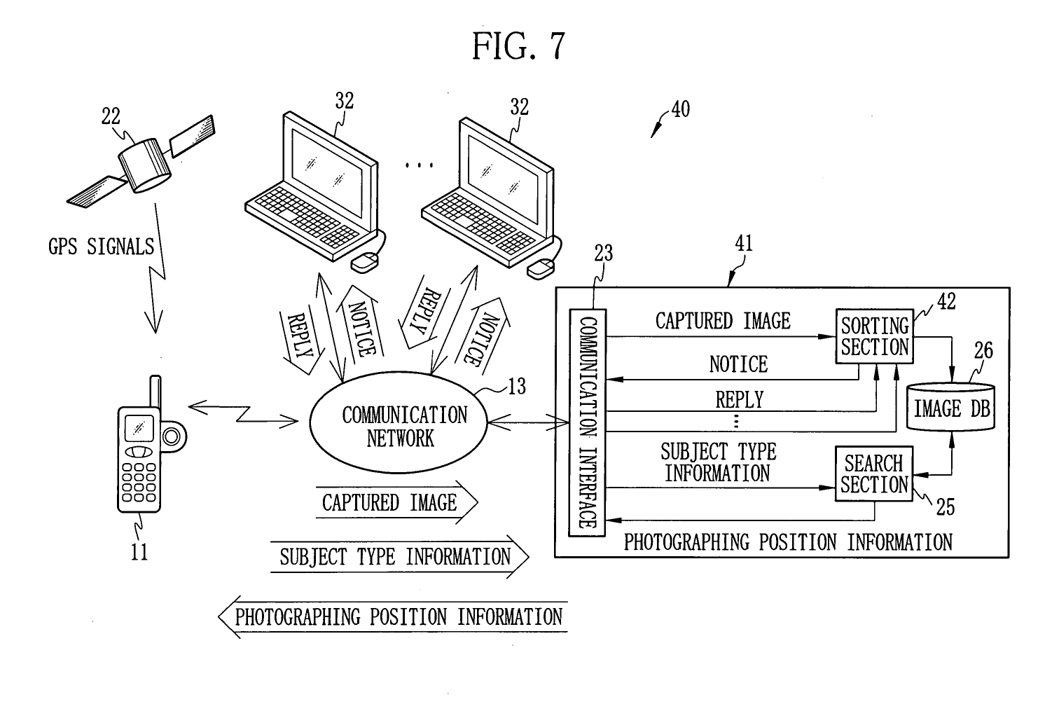

Next, a third embodiment of the present invention is explained. As shown in FIG. 7, an image capture system 40 is composed of the mobile phone 11, an image server 41, and a plurality of personal computers (PC) 32, all of which are connected to the communication network 13. In the drawing, the same components as those in the first and second embodiments are referred to by the same reference numerals, and the detailed explanations thereof are omitted.

The image server 41 is different from the image server 12 in a sorting section 42. The sorting section 42 sends a newly captured image to all the PCs 32, when the type of the subject for this image is not specified by the user, along with a notice that the captured image is not classifiable. Afterward, the sorting section 42 receives a plurality of replies (about the type of subject) from the PCs 32 through the communication network 13, and classifies and records the captured image into the image DB 26 according to the most frequent reply among those received.

In this manner, the image capture system 40 asks the experts in various fields for the type of the subject by way of the PCs 32 when the subject of the image captured on the mobile phone 11 is unspecifiable to the user. Since the captured image is classified according to the most frequent one of plural replies, the classification of the captured image becomes more appropriate.

Although the handheld terminal device is the mobile phone 11 in the first to third embodiments, the present invention is not limited to this. It should be understood that the handheld terminal device may be a digital camera or PDA (Personal Digital Assistance) with a communication function.

Various changes and modifications are possible in the present invention and may be understood to be within the present invention.

What is claimed is:

1. An image capture system including a handheld terminal device with an image capture function and a communication function, and an image server making data communication with said handheld terminal device through a communication network, said image capture system comprising:
(A) said handheld terminal device comprising:
a position determiner for determining a current position of said handheld terminal device;
a setup device which allows a user to specify a subject type of a subject to be captured;
a communication controller for transmitting said subject type specified on said setup device to said image server during a standby time to image capture and for transmitting a captured image together with photographing position information of said captured image to said image server after image capturing; and
an indicator for estimating a presence possibility of said subject within a certain area from said current position based on photographing position information of said subject received from said image server and for indicating said presence possibility to said user;
(B) said image server comprising:
a sorter for classifying said captured image received from said handheld terminal device according to said subject type;
a database to which said captured image classified by said sorter is recorded; and
a search device which searches said database for images under the same subject type as received from said handheld terminal device and transmits photographing position information derived from retrieved images to said handheld terminal device.

2. An image capture system described in claim 1, further comprising:
at least one personal computer connected to said communication network, said personal computer being configured to display said captured image and to accept an input of a reply about said subject type; and
said sorter transmitting said captured image to said personal computer along with a notice that said captured image is not classifiable when said subject type is not specified for said captured image, and then classifying said captured image according to said reply inputted to said personal computer.

3. An image capture system described in claim 2, wherein said personal computer is a plurality of personal computers,
wherein said sorter classifies said captured image according to the subject type most frequently inputted to said personal computers.

4. An image capture system described in claim 1, wherein said handheld terminal device is a mobile camera phone.

5. An image capture system described in claim 1, wherein said position determiner determines said current position by using GPS signals from GPS satellites.

6. An image capture system described in claim 1, wherein said indicator displays said presence possibility of said subject on a display panel provided in said handheld terminal device.

7. A handheld terminal device having an image capture function and a communication function, and making data communication with an image server through a communication network, said handheld terminal device comprising:
a position determiner for determining a current position of said handheld terminal device;
a setup device which allows a user to specify a subject type of a subject to be captured;
a communication controller for transmitting said subject type specified on said setup device to said image server during a standby time to image capture and for transmitting a captured image together with photographing position information of said captured image to said image server after image capturing; and
an indicator for estimating a presence possibility of said subject within a certain area from said current position based on photographing position information of said subject received from said image server and for indicating said presence possibility to said user.

8. An image server making data communication through a communication network with a handheld terminal device having an image capture function and a communication function, said image server comprising:
a sorter for classifying a captured image received from said handheld terminal device according to a subject type specified in said handheld terminal device;
a database to which said captured image classified by said sorter is recorded; and
a search device which searches said database for images under the same subject type as received from said handheld terminal device and transmits photographing position information derived from retrieved images to said handheld terminal device.

9. An image server described in claim 8, wherein said communication network connects to at least one personal computer which is configured to display said captured image and to accept an input of a reply about said subject type, and wherein said sorter transmits said captured image to said personal computer along with a notice that said captured image is not classifiable when said subject type is not specified for said captured image, and then classifies said captured image according to said reply inputted to said personal computer.

10. An image server described in claim 9, wherein said personal computer is a plurality of personal computers, and wherein said sorter classifies said captured image according to the subject type most frequently inputted to said personal computers.
